(19) United States
(12) Patent Application Publication
(10) Pub. No.: US 2026/0086059 A1
(43) Pub. Date: Mar. 26, 2026

(54) DETECTING DAMAGE TO INTEGRATED CIRCUITS

(71) Applicant: APPLE INC., Cupertino, CA (US)

(72) Inventor: Dong Zheng, Los Altos, CA (US)

(21) Appl. No.: 18/896,632

(22) Filed: Sep. 25, 2024

(51) Int. Cl. G01N 27/04

(52) U.S. Cl. CPC G01N 27/041; G01N 27/045

(57) ABSTRACT

A device includes an integrated circuit with multiple layers. A sensing trace is disposed on a first layer of the integrated circuit. The sensing trace includes a first node coupled to a ground and a second node coupled to a current source. The device also includes a resistor circuit coupled to the sensing trace. The device further includes a sensing circuit configured to detect damage to one or more layers of the multiple layers based on the sensing trace and the resistor circuit.

### BACKGROUND

### Technical Field

Embodiments described herein relate to integrated circuits, and more particularly, to detecting damage to integrated circuits.

### Description of the Related Art

Modern computer systems may include multiple circuits blocks designed to perform various functions. For example, such circuit blocks may include processors, processor cores configured to execute software or program instructions. Additionally, the circuit blocks may include memory circuits, mixed-signal or analog circuits, other integrated circuits and the like. The integrated circuits used in modern computer systems are often complex and delicate circuits. Damage to the integrated circuits may occur at various times. For example, damage to the integrated circuits may occur during the manufacture, testing, and/or installation of the integrated circuits.

The damage to the integrated circuits is often hard to detect. For example, damage to the integrated circuit on a microscopic or micron scale may not be visible and is often very difficult to detect and/or diagnose.

### SUMMARY OF VARIOUS EMBODIMENTS

Various embodiments of an integrated circuit are disclosed. Broadly speaking, an integrated circuit that includes components, devices, circuits, etc., for detecting damage to the integrated circuit are contemplated. The integrated circuit may include one or more sensing traces and one or more resistors coupled to the one or more sensing traces. A current source provides current to the one or more sensing traces and one or more sensing circuits may determine, measure, etc., the resistances of the one or more sensing traces. The one or more sensing circuits may detect damage to the integrated circuit based on the resistances of the one or more sensing traces and the one or more target resistances.

### BRIEF DESCRIPTION OF THE DRAWINGS

The following detailed description makes reference to the accompanying drawings, which are now briefly described.

FIG. 1A illustrates a cross-sectional side view of an integrated circuit, in accordance with one or more embodiments of the present disclosure.

FIG. 1B illustrates a top view of an integrated circuit, in accordance with one or more embodiments of the present disclosure.

FIG. 2A illustrates a cross-sectional side view of an integrated circuit, in accordance with one or more embodiments of the present disclosure.

FIG. 2B illustrates a top view of an integrated circuit, in accordance with one or more embodiments of the present disclosure.

FIG. 3 illustrates a top view of an integrated circuit, in accordance with one or more embodiments of the present disclosure.

FIG. 4 illustrates a cross-sectional side view of an integrated circuit, in accordance with one or more embodiments of the present disclosure.

FIG. 5A illustrates a top view of an integrated circuit, in accordance with one or more embodiments of the present disclosure.

FIG. 5B illustrates a top view of an integrated circuit, in accordance with one or more embodiments of the present disclosure.

FIG. 6 illustrates a flow diagram depicting an embodiment of a method for detecting damage to an integrated circuit, in accordance with one or more embodiments of the present disclosure.

FIG. 7 illustrates a block diagram of an example system, in accordance with one or more embodiments of the present disclosure.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

As discussed above, modern computer systems may include multiple circuits. The integrated circuits used in these modern computer systems are often complex and/or delicate systems. Damage to the integrated circuits may occur at various times. For example, damage to the integrated circuits may occur during the manufacture, testing, and/or installation of the integrated circuits. The damage to the integrated circuits is often hard to detect. For example, damage to the integrated circuit on a microscopic or micron scale may not be visible and is often very difficult to detect and/or diagnose. Even minute or tiny damaged portions on an integrated circuit may cause the integrated circuit to break, malfunction, not operate properly, etc. In addition, some types of integrated circuits may not have a protective layer to prevent mechanical/physical damage. For example, some integrated circuits (e.g., an optical sensing circuit) have other circuits (e.g., photodiodes) on a top layer that should remain exposed in order for the integrated circuit to operate properly.

In one embodiment, it may be useful to detect certain types of damage to an integrated circuit. For example, it may be useful to detect physical and/or mechanical damage that may occur during manufacture, testing, and/or installation of an integrated circuit. Generally, detecting damage on an integrated circuit may be a more time consuming and complex process. For example, a microscope or other magnification device may be used to view a top/upper surface of the integrated circuit to detect scratches, gouges, dents, and/or other physical/mechanical damage.

The embodiments illustrated in the drawings and described below may provide techniques detecting damage to an integrated circuit more quickly, easily, and/or efficiently. The integrated circuit may include one or more sensing traces and one or more resistors coupled to the one or more sensing traces. A current source provides current to the one or more sensing traces and one or more sensing circuits may determine, measure, etc., the resistances of the one or more sensing traces. The one or more sensing circuits may detect damage to the integrated circuit based on the resistances of the one or more sensing traces and the one or more target resistances.

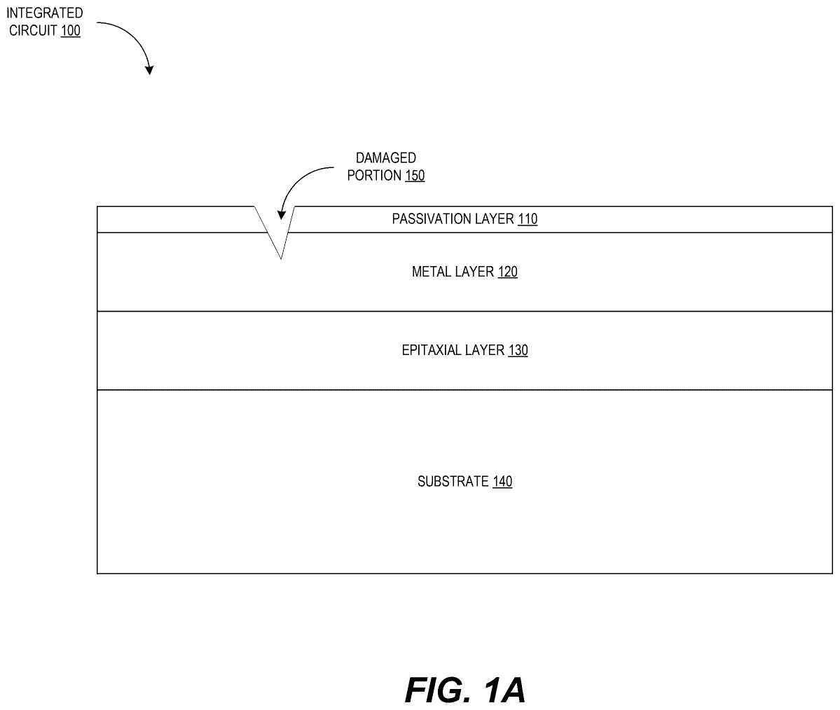

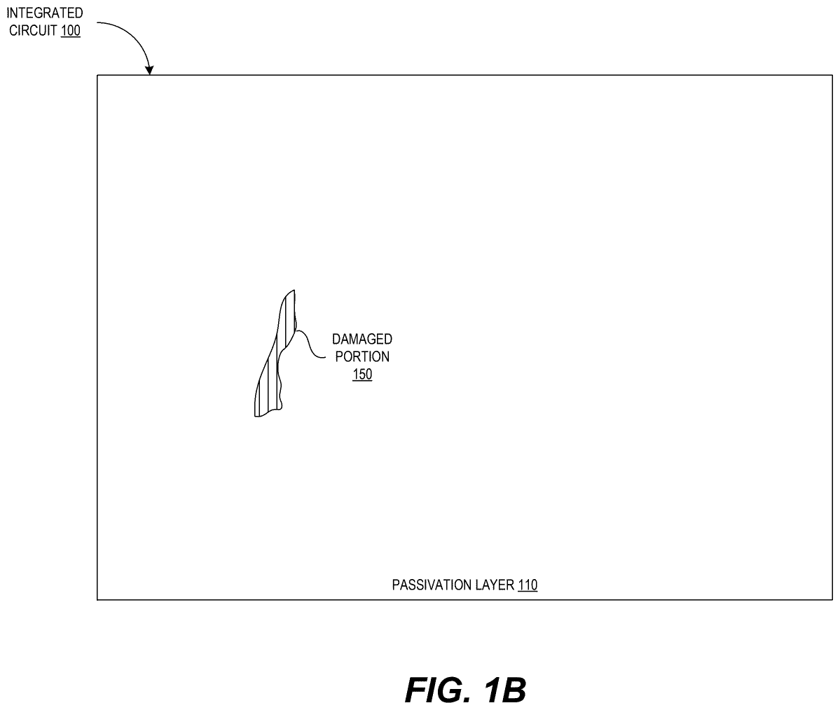

FIG. 1A illustrates a cross-sectional side view of an integrated circuit 100, in accordance with one or more embodiments of the present disclosure. The integrated circuit 100 may be a die, silicon die, etc. For example, the integrated circuit 100 may be an active die such as a logic die or SOC die including an active component(s) such as, but not limited to, a microprocessor, memory, RF transceiver, mixed-signal component, transistors (e.g., field-effect transistors (FETs), thin-film transistors (TFTs), optical sensing/sensor circuits, photodiodes, etc.

The integrated circuit includes a substrate 140, an epitaxial layer 130, a metal layer 120, and a passivation layer 110. Each of the substrate 140, the epitaxial layer 130, the metal layer 120, and the passivation layer 110 may include multiple other layers/sublayers, levels, planes, stratus, etc. For example, the metal layer 120 may include multiple metal sublayers and/or multiple dielectric sublayers (not illustrated in FIG. 1A).

In one embodiment, the substrate 140 may be a layer on which other layers, devices, circuits, components, etc., are placed, formed, constructed, etc. For example, the substrate 140 may server as a base layer for the integrated circuit 100. The substrate 140 may be composed of various materials such as silicon, gallium nitride, silicon carbide, gallium arsenide, aluminum nitride, silicon on sapphire, etc.

The epitaxial layer 130 may be formed, grown, deposited, etc., on top of the substrate 140. In one embodiment, the epitaxial layer 130 may be a layer where various device, circuits, and/or components may be form, constructed, deposited, etc. For example, active devices such as transistors, FETs, TFTs, etc., may be formed within the epitaxial layer 130. The epitaxial layer 130 may include multiple layers or sub-layers (not illustrated in FIG. 1A). For example, the different active devices (e.g., different transistors) may be formed in different sub-layers of the epitaxial layer 130. In another example, different portions of an active device may be in different sub-layers of the epitaxial layer 130.

The metal layer 120 may be formed, grown, deposited, etc., on top of the epitaxial layer 130. In one embodiment, the metal layer 120 may include lines, traces, connections, etc., that may provide connections between devices, circuits, components, etc., of the epitaxial layer 130. For example, the metal layer 120 may include traces (not illustrated in FIG. 1A) that may provide lateral connections or lateral interconnect paths (e.g., connections across the metal layer 120). In another example, the metal layer 120 may include vias (not illustrated in FIG. 1A) that may provide vertical connections or vertical interconnect paths. The vias may extend through the metal layer 120 and/or through the epitaxial layer 130. The traces and the vias may allow for the interconnection of different devices, circuits, components, etc., of the epitaxial layer 130.

The passivation layer 110 may be formed, grown, deposited, etc., on top of the metal layer 120. The passivation layer 110 is not sufficient to protect the integrated circuit 100 from mechanical and physical damage and an additional protective layer on top of the passivation layer 110 may not be used for various reasons. For example, the integrated circuit may be an optical sensing circuit that includes photodiodes. For the photodiodes to work properly, the photodiodes should not be covered or obstructed (e.g., should not be covered by an additional protective layer such as an overmold, a plate, etc.).

As illustrated in FIG. 1A, the integrated circuit 100 includes a damaged portion 150. The damaged portion 150 may be physical/mechanical damage to the integrated circuit 100. For example, the top of the integrated circuit 100 (e.g., the passivation layer 110 and the metal layer 120) may be scratched, scraped, dented, and/or otherwise damaged. Although the damaged portion 150 is shown as extending from the passivation layer 110 to the metal layer 120, the damaged portion 150 may extend further down through the integrated circuit 100 in other embodiments (e.g., may extend from the passivation layer 110 to the epitaxial layer 130).

The damage to the integrated circuit 100 (e.g., damaged portion 150) may occur at various times. For example, damage (e.g., physical/mechanical damage) to the integrated circuit 100) may occur during a manufacturing process (e.g., during the manufacture of the integrated circuit 100). In another example, the damage may occur during a testing/inspection process. In a further example, the damage may occur during an installation process (e.g., when the integrated circuit 100 is installed, integrated, etc., on another device/component).

In one embodiment, the damage to the integrated circuit 100 may be difficult to detect. For example, the damaged portion 150 may be microns in size and may not be visible without a magnification device (e.g., a microscope). Detecting the damage to the integrated circuit 100 is often a time consuming, expensive, and/or manual process.

FIG. 1B illustrates a top view of an integrated circuit 100, in accordance with one or more embodiments of the present disclosure. The integrated circuit 100 includes substrate 140, epitaxial layer 130, metal layer 120, and passivation layer 110, which are not visible from the top view of the integrated circuit 100. Each of the substrate 140, the epitaxial layer 130, the metal layer 120, and the passivation layer 110 may include multiple other layers, levels, planes, stratus, etc.

The integrated circuit 100 includes damaged portion 150 (e.g., physical/mechanical damage such as a scratch, dent, etc.). From the top view, other layers of the integrated circuit 100 may be visible in the damaged portion 150. For example, portions of the epitaxial layer 130 and/or metal layer 120 may be visible in the damaged portion 150, depending on the deepness of the damaged portion 150.

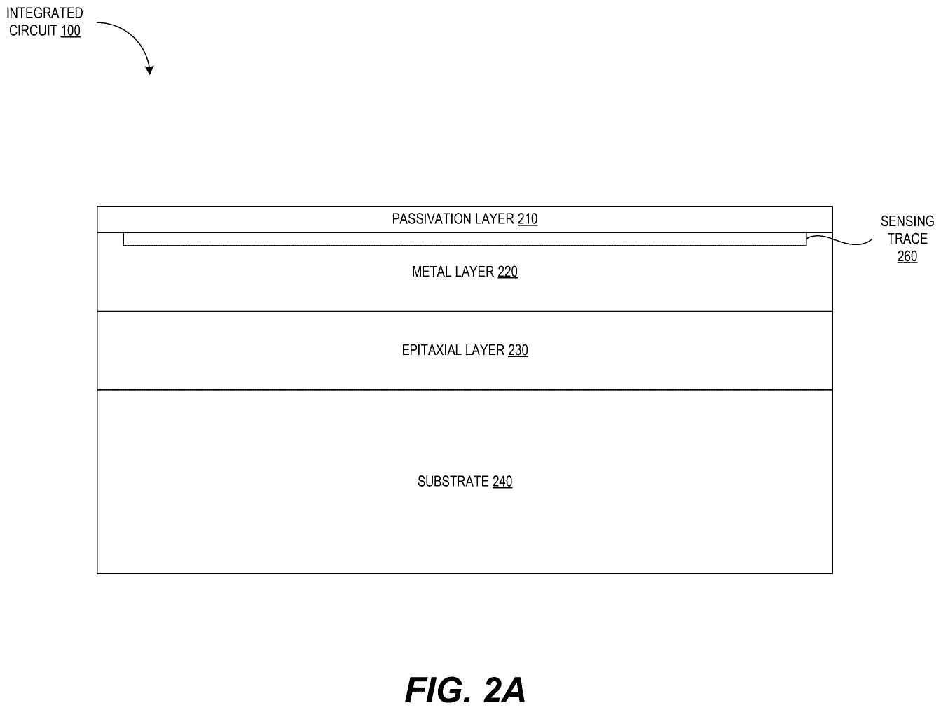

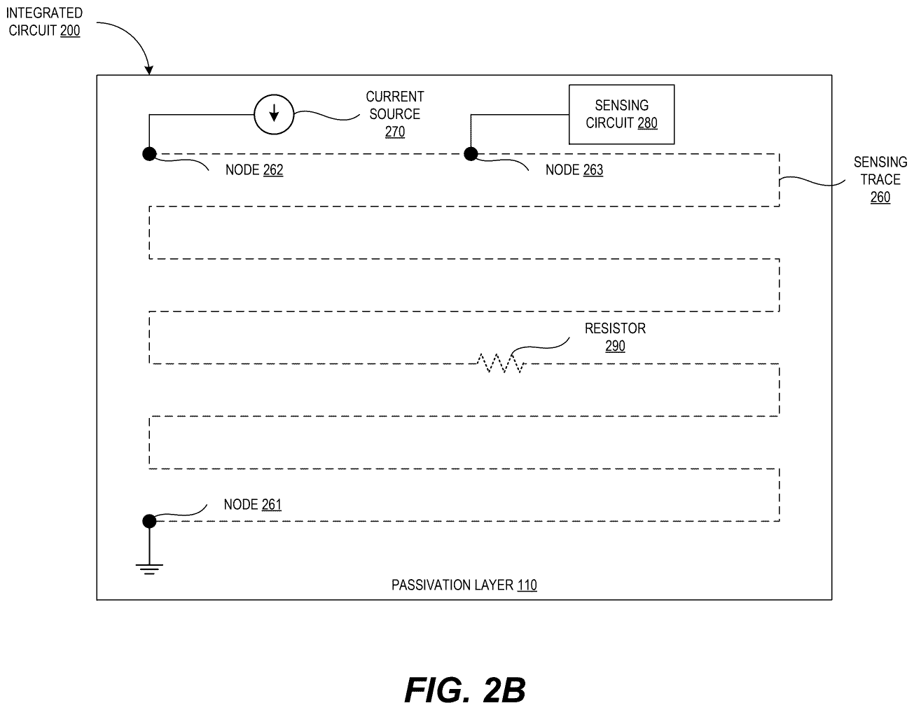

FIG. 2A is a side cross-sectional view of an integrated circuit 200, in accordance with one or more embodiments of the present disclosure. The integrated circuit 200 includes substrate 240, epitaxial layer 230, metal layer 220, and passivation layer 210 (as illustrated and discussed in FIG. 2A). The substrate 240 is similar to the substrate 140 (illustrated in FIG. 1A), the epitaxial layer 230 is similar to epitaxial layer 130 (illustrated in FIG. 1A), the metal layer 220 is similar to metal layer 120 (illustrated in FIG. 1A), and the passivation layer 210 is similar to passivation layer 110 (illustrated in FIG. 1A). Each of the substrate 240, the epitaxial layer 230, the metal layer 220, and the passivation layer 210 may include multiple other layers, levels, planes, stratus, etc.

In one embodiment, the integrated circuit 200 includes a sensing trace 260. The sensing trace 260 may be a connection, line, wire, and/or some other conductive path. The sensing trace 260 may be referred to as a signal trace, circuit trace, etc. The sensing trace 260 is located in the metal layer 220. The sensing trace 260 may be formed, deposited, along with other wires, traces, connections, etc., when the metal layer 220 is formed, deposited, etc. In some embodiments, the sensing trace 260 may be connected/coupled to a current source, a resistor, and a sensing circuit. The current source, resistor, and sensing circuit are not show in FIG. 2A, but are illustrated in FIG. 2B below.

Although the sensing trace 260 is illustrated as being located at the top of the metal layer 220, the sensing trace 260 may be placed in different locations in other embodiments. For example, the sensing trace 260 may be located in the middle of the metal layer 220. In another example, the sensing trace 260 may be located in the passivation layer 210 (e.g., may be formed on top of the metal layer 220). In a further example, the sensing trace 260 may be located in multiple layers (e.g., may be in both the metal layer 220 and the passivation layer 210).

In one embodiment, the sensing trace 260, current source, resistor, and sensing circuit may be used to detect damage to the integrated circuit 200. The use of the sensing trace 260, current source, resistor, and sensing circuit may be used to detect damage to the integrated circuit 200 as discussed in more detail below.

FIG. 2B illustrates a top view of an integrated circuit 200, in accordance with one or more embodiments of the present disclosure. The integrated circuit 200 includes substrate 240, epitaxial layer 230, metal layer 220, and passivation layer 210, some of which are not visible from the top view of the integrated circuit 200. Each of the substrate 240, the epitaxial layer 230, the metal layer 220, and the passivation layer 210 may include multiple other layers, levels, planes, stratus, etc.

As discussed above, integrated circuit 200 includes sensing trace 260 (illustrated by the dashed line). The sensing trace 260 may be located in the metal layer 220 (or in any other appropriate layer of the integrated circuit 200). As illustrated in FIG. 2B, the sensing trace 260 is connected/coupled to a current source 270, a resistor 290, and a sensing circuit 280. The current source 270 may be any circuit, device, module, component, etc., that may generate, output, provide, etc., a current. The current source is coupled to sensing trace 260 at node 262. The resistor 290 may be any circuit, device, module, component, etc., that may resist the flow of current. The sensing circuit 280 may be any device, circuit, that may measure, sense, determine, calculate, etc., the resistance of current flowing through the sensing trace 260. For example, the sensing circuit 280 may be an analog-to-digital circuit (ADC) and/or other logic/circuitry. The sensing circuit 280 is coupled to the sensing trace 260 at node 263. The sensing trace 260 is also coupled to ground at node 261.

In one embodiment, the current source 270 may provide a current to the sensing trace 260. For example, the current source 270 may generate a current that flows through the sensing trace 260. As the current flows through the sensing trace 260, it also flows through the resistor 290. The resistor 290 may produce, generate, cause, etc., resistance to the current from the current source 270.

In one embodiment, the sensing circuit 280 may detect damage to one or layers of the integrated circuit 200 based on the sensing trace 260 and the resistor 290. For example, the sensing circuit 280 may determine, measure, detect, sense, the resistance of the sensing trace 260 as current (from current source 270) flows through the sensing trace 260. Because the resistance of the resistor 290 may be known and the amount of current generated by the current source 270 may be known (e.g., may be controlled by another circuit, such as a control circuit), the target resistance of the sensing trace 260 for a particular current can be determined.

In one embodiment, the sensing circuit 280 may determine the target resistance of the sensing trace 260 based on one or more temperatures of the integrated circuit 200. For example, the temperature of the integrated circuit 200 may increase when the integrated circuit 200 is in use/operation. The resistance of the sensing trace 260 may increase as the temperature of the integrated circuit 200 and/or the sensing trace 260 increases, even if there is no damage to the integrated circuit 200. The sensing circuit 280 may obtain (e.g., measure or receive) one or more temperatures of one or more portions of the integrated circuit 200 (e.g., portions that include the sensing trace 260) and may calculate, determine, etc., the target resistance based on the one or more temperatures (e.g., may increase the target resistance based on the one or more temperatures). The integrated circuit 200 may optionally include one or more temperature sensors and/or the sensing circuit 280 may receive the temperatures from an external device/component.

In one embodiment, the sensing circuit 280 may determine whether the detected, measured, etc., resistance of the sensing trace 260 matches the target resistance (e.g., is equal to the target resistance or is within a range/threshold of the target resistance). If the resistance of the sensing trace 260 matches the target resistance, the sensing circuit 280 may determine that there is no damage (e.g., no mechanical/physical damage) to the integrated circuit 200. If the resistance of the sensing trace 260 does not match the target resistance (or is not within a threshold/range of the target resistance), the sensing circuit 280 may determine that there is damage (or that there may be damage) to the integrated circuit 200. For example, if the resistance of the sensing trace 260 is larger than the target resistance or is smaller than the target resistance, the sensing circuit 280 may determine that there may be damage to the integrated circuit 200.

In one embodiment, the sensing circuit 280 may determine an extent of damage to the integrated circuit 200. For example, the sensing circuit 280 may determine how badly the integrated circuit 200 is damaged and/or how much damage has occurred, based on the resistance of the sensing trace 260. The sensing circuit 280 may use different ranges of resistance to classify, determine, measure, etc., the extent of damage to the integrated circuit 200. For example, if the resistance of the sensing trace 260 is within a first range of the target resistance, the sensing circuit 280 may determine that there is minor damage to the integrated circuit 200 and that the integrated circuit 200 may still be usable. In another example, if the resistance of the sensing trace 260 is in a second range (e.g., a second range that is outside or greater than the first range) the sensing circuit 280 may determine that there is more damage to the integrated circuit 200 and that the integrated circuit 200 may not be usable.

As discussed above, it may not be possible to use a protective layer to protect the integrated circuit 200 and the passivation layer 210 may not be enough to protect the integrated circuit 200. The sensing trace 260 and the resistor 290 may allow the sensing circuit 280 to detect damage to the integrated circuit 200 more quickly and efficiently. For example, rather than using a microscope to visually inspect the integrated circuit 200, the sensing circuit 280 may detect damage to the integrated circuit using the resistance of the sensing trace 260 and the target resistance, as discussed above.

Although the current source 270 and the sensing circuit 280 are illustrated as part of the integrated circuit 200, one or more of the current source 270 and the sensing circuit 280 may be separate from the integrated circuit 200 in other embodiments. For example, the current source 270 and the sensing circuit 280 may be in an external device/component and may be coupled to the integrated circuit 200 via the nodes 262 and node 263 during a testing process to detect damage in the integrated circuit 200.

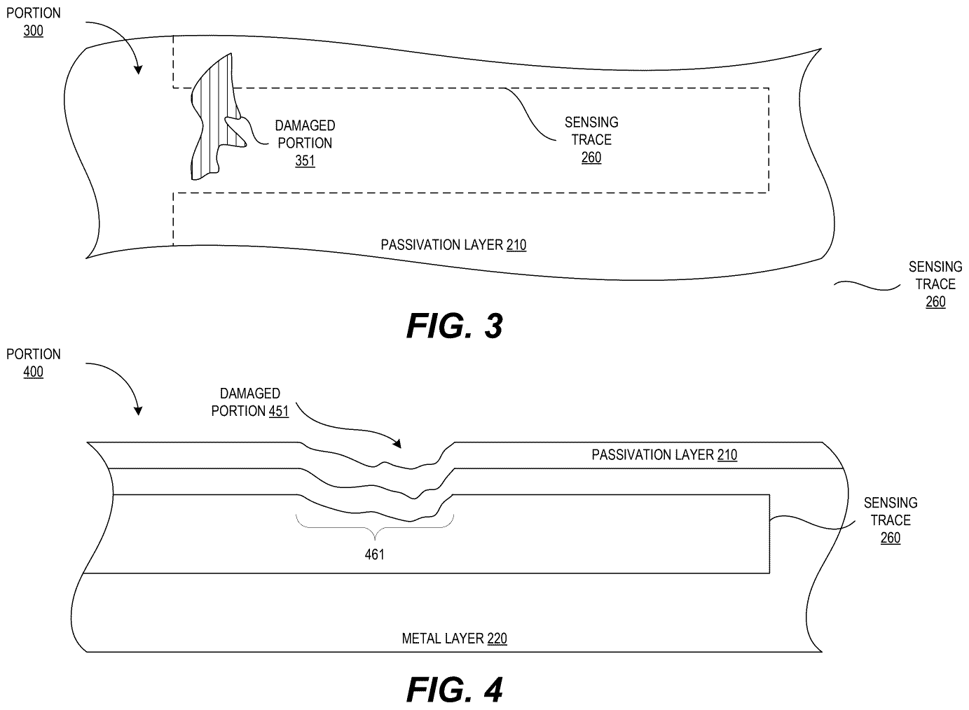

FIG. 3 illustrates a top view of portion 300 of integrated circuit 200, in accordance with one or more embodiments of the present disclosure. As discussed above, the integrated circuit 200 includes substrate 240, epitaxial layer 230, metal layer 220, and passivation layer 210, which are not visible from the top view of the integrated circuit 200. Each of the substrate 240, the epitaxial layer 230, the metal layer 220, and the passivation layer 210 may include multiple other layers, levels, planes, stratus, etc.

As illustrated in FIG. 3, the sensing trace 260 is disposed, located, etc., within the integrated circuit in multiple horizontal directions. For examples, the sensing trace 260 may be disposed within the integrated circuit 200 in going in a sideways direction within a layer of the integrated circuit 200.

Also as illustrated in FIG. 3, the damaged portion 351 may cross, break, disrupt, disconnect, etc., a portion of the sensing trace 260. For example, the damage to the integrated circuit my cause a break in a portion of the sensing trace 260. When a break occurs in the portion of the sensing trace 260, current from the current source may not be able to flow through the sensing trace 260. When the sensing circuit 280 measures the resistance of the sensing trace 260, the damaged portion 351 (e.g., the physical/mechanical damage) will cause the resistance of the sensing trace 260 to increase and become larger/greater than the target resistance. This may indicate that there is damage in the integrated circuit 200 along one or more horizontal directions.

FIG. 4 is a side cross-sectional view of a portion 400 of integrated circuit 200, in accordance with one or more embodiments of the present disclosure. As discussed above, the integrated circuit 200 includes substrate 240, epitaxial layer 230, metal layer 220, and passivation layer 210. The substrate 240 and the epitaxial layer 230 are not are not visible in FIG. 4. Each of the substrate 240, the epitaxial layer 230, the metal layer 220, and the passivation layer 210 may include multiple other layers, levels, planes, stratus, etc.

As illustrated in FIG. 4, the sensing trace 260 is disposed, located, etc., within the integrated circuit 200 in a vertical direction (e.g., up to down and vice versa). For example, at least portions of the sensing trace 260 may span a vertical dimension of the integrated circuit 200.

Also as illustrated in FIG. 3, the damaged portion 451 may cause the portion 461 of the sensing trace 260 to deform, bend, move, etc. For example, the portion 461 may deform downward. When the deformation of sensing trace 260 occurs, the resistance of the current flowing through the sensing trace 260 may change. For example, when the sensing circuit 280 measures the resistance of the sensing trace 260, the damaged portion 451 (e.g., the physical/mechanical damage) will cause the resistance of the sensing trace 260 to decrease and become smaller/less than the target resistance. The resistance of the sensing trace 260 may decrease because the deformation or movement of the portion 461 may cause the portion 461 to move closer to (or come into contact with) other portions of the sensing trace 260, causing a short circuit. This may indicate that there is damage in the integrated circuit 200 along a vertical direction of the integrated circuit.

In addition, although resistor 290 is illustrated in FIG. 2B (and other resistors are illustrated in other figures), the resistor 290 (and the other resistors) may be optional in some embodiments. For example, the resistor 290 may not be used in the integrated circuit 200 if the sensing circuit 280 is not used to detect deformed/bent traces. If the resistor 290 is not used, the sensing circuit 280 is still able to detect breaks, disconnects, etc., in the sensing trace 260.

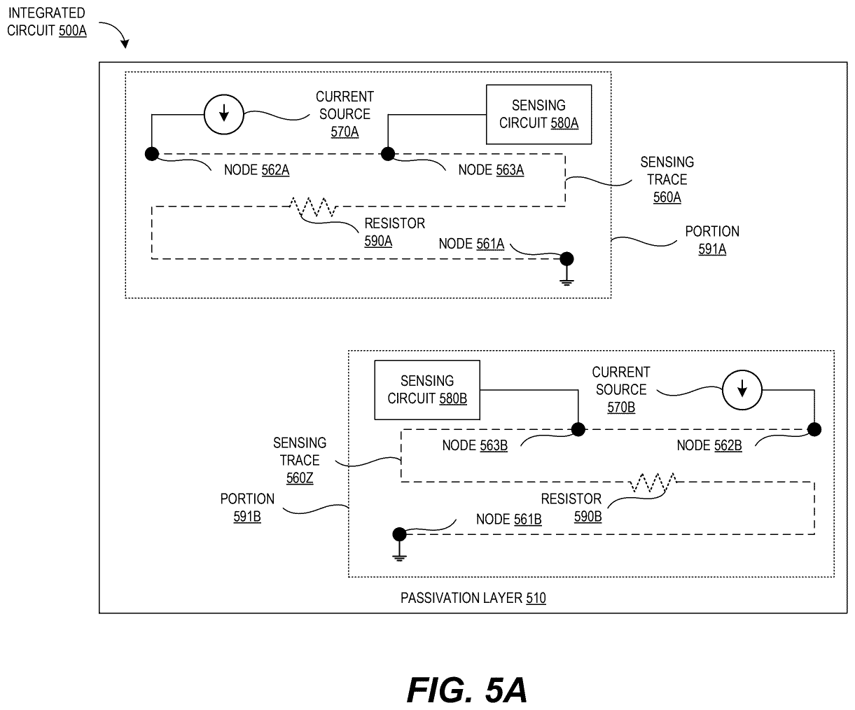

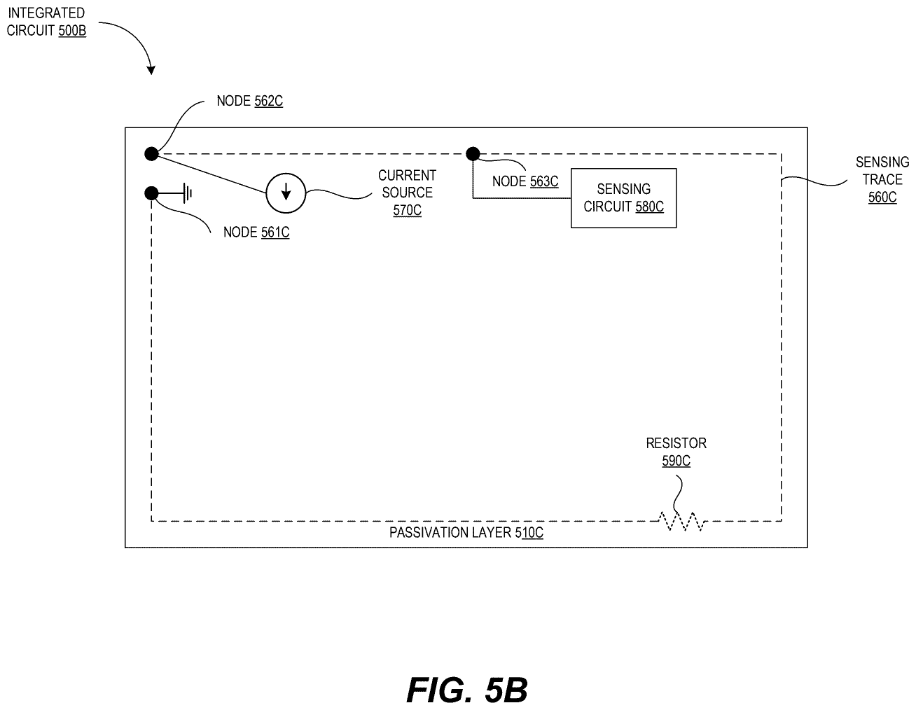

FIG. 5A illustrates a top view of an integrated circuit 500A, in accordance with one or more embodiments of the present disclosure. The integrated circuit 500A includes a substrate, epitaxial layer, metal layer, and passivation layer 510. The substrate, epitaxial layer, and metal layer are not visible from the top view of the integrated circuit 500A. Each of the substrate, the epitaxial layer, the metal layer, and the passivation layer may include multiple other layers, levels, planes, stratus, etc.

As discussed above, integrated circuit 500A includes sensing traces 560A and 560B (illustrated by the dashed line). The sensing traces 560A and 560B may be located in the metal layer 520 (or in any other appropriate layer of the integrated circuit 500A). Sensing trace 560A is connected/coupled to a current source 570A, a resistor 590A, and a sensing circuit 580A. Sensing trace 560B is connected/coupled to a current source 570B, a resistor 590B, and a sensing circuit 580B.

The current source 570A is coupled to sensing trace 560A at node 562A and current source 570B is coupled to sensing trace 560B at node 562B. The sensing circuit 580A is coupled to the sensing trace 560A at node 563A and sensing circuit 580B is coupled to the sensing trace 560B at node 563B. The sensing trace 560A is also coupled to ground at node 561A and the sensing trace 560B is coupled to ground at node 561B.

As discussed above, the current sources 570A and 570B may provide currents to the sensing traces 560A and 560B. As the currents flow through the sensing traces 560A and 560B, it also flows through the resistors 590A and 590B. The resistors 590A and 590B may produce, generate, cause, etc., resistances to the currents from the current sources 570A and 570B. The sensing circuits 580A and 580B may detect damage to one or layers of the integrated circuit 500A based on the sensing traces 560A and 560B and the resistors 590A and 590B, similar to as described in FIG. 2B. For example, the sensing circuit 580A may determine, measure, detect, sense, the resistance of the sensing trace 560A as current (from current source 570A) flows through the sensing trace 560A. The sensing circuit 580A may determine whether the detected, measured, etc., resistance of the sensing trace 560A matches the target resistance (or is within a range/threshold of the target resistance). If the resistance of the sensing trace 560A matches the target resistance, the sensing circuit 580A may determine that there is no damage (e.g., no mechanical/physical damage) to the integrated circuit 500A. If the resistance of the sensing trace 560A does not match the target resistance (or is not within a threshold/range of the target resistance), the sensing circuit 580A may determine that there is damage to the integrated circuit 500A.

As illustrated in FIG. 5A, the sensing trace 560A may be used to detect damage in the portion 591A of the integrated circuit 500A (e.g., in the portion outlined by the upper dotted box). The sensing trace 560B may be used to detect damage in the portion 591B of the integrated circuit 500A (e.g., in the portion outlined by the lower dotted box). In one embodiment, one or more active devices (e.g., transistors, FETs, other circuits, etc.) may be located in the portions 591A and/or 591B. For example, there may be one or more FETs located below the sensing trace 560A (e.g., in the epitaxial layer of the integrated circuit 500A, below the sensing trace 560A). The sensing trace 560A may allow the sensing circuit 580A to detect damage to the one or more FETs.

FIG. 5B illustrates a top view of an integrated circuit 500B, in accordance with one or more embodiments of the present disclosure. The integrated circuit 500B includes a substrate, epitaxial layer, metal layer, and passivation layer 510. The substrate, epitaxial layer, and metal layer are not visible from the top view of the integrated circuit 500B. Each of the substrate, the epitaxial layer, the metal layer, and the passivation layer may include multiple other layers, levels, planes, stratus, etc.

As discussed above, integrated circuit 500B includes sensing trace 560C (illustrated by the dashed line). The sensing trace 560C may be located in the metal layer (or in any other appropriate layer of the integrated circuit 500B). Sensing trace 560C is connected/coupled to a current source 570C, a resistor 590C. The current source 570C is coupled to sensing trace 560C at node 562C. The sensing circuit 580C is coupled to the sensing trace 560C at node 563C. The sensing trace 560C is also coupled to ground at node 561C.

As discussed above, the current source 570C may provide current to the sensing trace 560C. As the current flows through sensing trace 560C, it also flows through the resistor 590C. The resistor 590C may produce, generate, cause, etc., resistances to the current. The sensing circuit 580C may detect damage to one or layers of the integrated circuit 500B based on the sensing trace 560C and the resistor 590C, similar to as described in FIG. 2B.

As illustrated in FIG. 5B, the sensing trace 560C is disposed along an outer perimeter of the integrated circuit 500B. This may allow the sensing circuit 580C to detect damage to the side surfaces of the integrated circuit.

Structures such as those shown in FIGS. 1A-5B for detecting damage to an integrated circuit may be referred to using functional language. In some embodiments, these structures may be described as including “means for applying a current to a sensing trace disposed on a first layer of an integrated circuit,” “means for determining a resistance of the sensing trace,” “means for detecting damage to the integrated circuit based on the resistance of the sensing trace and a target resistance,” “means for determining whether the resistance of the sensing trace matches the target resistance,” “means for determining that there is damage to the integrated circuit when the resistance of the sensing trace does not match the target resistance,” “means for determining that there is no damage to the integrated circuit when the resistance of the sensing trace matches the target resistance.”

The corresponding structure for “means for applying a current to a sensing trace disposed on a first layer of an integrated circuit,” are current source 270, sensing trace 260, and/or node 262 as well as equivalents. The corresponding structure for “means for determining a resistance of the sensing trace” are sensing circuit 280, resistor 290, sensing trace 260, and/or node 265 as well as equivalents. The corresponding structure for “means for detecting damage to the integrated circuit based on the resistance of the sensing trace and a target resistance” are sensing circuit 280, resistor 290, sensing trace 260, and/or node 265 as well as equivalents. The corresponding structure for “means for determining whether the resistance of the sensing trace matches the target resistance” are sensing circuit 280, resistor 290, sensing trace 260, and/or node 265. The corresponding structure for “means for determining that there is damage to the integrated circuit when the resistance of the sensing trace does not match the target resistance” are sensing circuit 280, resistor 290, sensing trace 260, and/or node 265. The corresponding structure for “means for determining that there is no damage to the integrated circuit when the resistance of the sensing trace matches the target resistance” are sensing circuit 280, resistor 290, sensing trace 260, and/or node 265.

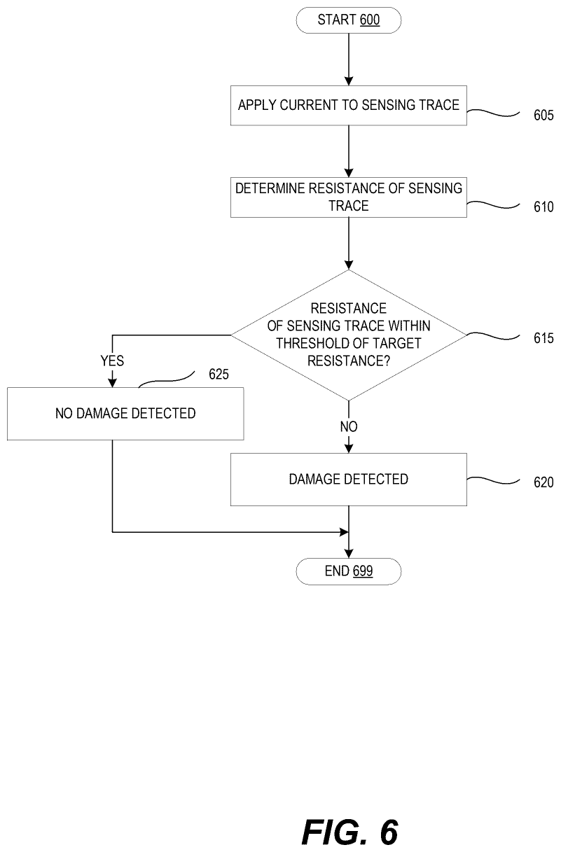

FIG. 6 illustrates a flow diagram depicting an embodiment of a method for detecting damage in an integrated circuit, in accordance with one or more embodiments of the present disclosure. The method, which may be applied to one or more of integrated circuits, sensing circuits, sensing traces, current sources, and/or resistors, as illustrated in FIGS. 1A to 5B, starts at the block 600.

The method includes obtaining applying a current to a sensing trace at block 605. For example, a current source may be used to generate and provide the current to the sensing trace. At block 610, the method includes determining the resistance of the sensing trace. For example, the method may measure, sense, detect, etc., the resistance of the current flowing the sensing trace.

At block 615, the method includes determining whether the resistance of the sensing trace is within a threshold (e.g., a range) of the target resistance. For example, the target resistance may be known, determined, etc., based on a resistor that is coupled to the sensing trace. The method may determine whether the resistance of the sensing trace (e.g., the detected/sensed resistance) is equal to a target resistance or is within a threshold/range of the target resistance. If the target resistance matches the target resistance or is within a threshold/range of the target resistance, the method may determine that there is no damage to the integrated circuit at block 625. If the target resistance does not match the target resistance and/or is not within a threshold/range of the target resistance, the method may determine that there is damage to the integrated circuit at block 620.

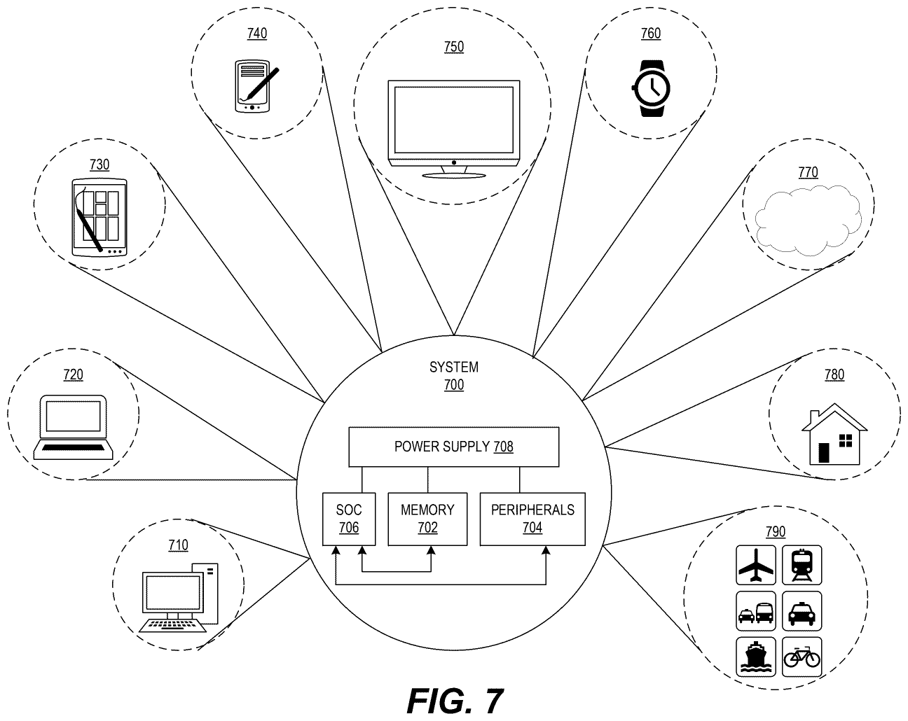

FIG. 7 illustrates a block diagram of an example system 700, in accordance with one or more embodiments of the present disclosure. The system 7000 may incorporate and/or otherwise utilize the circuits, devices, components, methods, functions, and/or mechanisms described herein. In the illustrated embodiment, the system 700 includes at least one instance of a system on chip (SoC) 707 which may include multiple types of processing units, such as a central processing unit (CPU), a graphics processing unit (GPU), or otherwise, a communication fabric, and interfaces to memories and input/output devices. In some embodiments, one or more processors in SoC 707 includes multiple execution lanes and an instruction issue queue. In various embodiments, SoC 707 is coupled to external memory 702, peripherals 704, and power supply 708. The system 700 may use plates (with regions and/or vias) that are coupled to various components (e.g., coupled to SoC 707).

A power supply 708 is also provided which supplies the supply voltages to SoC 707 as well as one or more supply voltages to the memory 702 and/or the peripherals 704. In various embodiments, power supply 708 represents a battery (e.g., a rechargeable battery in a smart phone, laptop or tablet computer, or other device). In some embodiments, more than one instance of SoC 707 is included (and more than one external memory 702 is included as well).

The memory 702 is any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices are coupled onto a circuit board to form memory modules such as single inline memory modules (SIMMs), dual inline memory modules (DIMMs), etc. Alternatively, the devices are mounted with a SoC or an integrated circuit in a chip-on-chip configuration, a package-on-package configuration, or a multi-chip module configuration.

The peripherals 704 include any desired circuitry, depending on the type of system 700. For example, in one embodiment, peripherals 704 includes devices for various types of wireless communication, such as Wi-Fi, Bluetooth, cellular, global positioning system, etc. In some embodiments, the peripherals 704 also include additional storage, including RAM storage, solid state storage, or disk storage. The peripherals 704 include user interface devices such as a display screen, including touch display screens or multitouch display screens, keyboard or other input devices, microphones, speakers, etc.

As illustrated, system 700 is shown to have application in a wide range of areas. For example, system 700 may be utilized as part of the chips, circuitry, components, etc., of a desktop computer 710, laptop computer 720, tablet computer 730, cellular or mobile phone 740, or television 750 (or set-top box coupled to a television). Also illustrated is a smartwatch and health monitoring device 760. In some embodiments, smartwatch may include a variety of general-purpose computing related functions. For example, smartwatch may provide access to email, cellphone service, a user calendar, and so on. In various embodiments, a health monitoring device may be a dedicated medical device or otherwise include dedicated health related functionality. For example, a health monitoring device may monitor a user's vital signs, track proximity of a user to other users for the purpose of epidemiological social distancing, contact tracing, provide communication to an emergency service in the event of a health crisis, and so on. In various embodiments, the above-mentioned smartwatch may or may not include some or any health monitoring related functions. Other wearable devices are contemplated as well, such as devices worn around the neck, devices that are implantable in the human body, glasses designed to provide an augmented and/or virtual reality experience, and so on.

System 700 may further be used as part of a cloud-based service(s) 770. For example, the previously mentioned devices, and/or other devices, may access computing resources in the cloud (i.e., remotely located hardware and/or software resources). Still further, system 700 may be utilized in one or more devices of a home other than those previously mentioned. For example, appliances within the home may monitor and detect conditions that warrant attention. For example, various devices within the home (e.g., a refrigerator, a cooling system, etc.) may monitor the status of the device and provide an alert to the homeowner (or, for example, a repair facility) should a particular event be detected. Alternatively, a thermostat may monitor the temperature in the home and may automate adjustments to a heating/cooling system based on a history of responses to various conditions by the homeowner. Also illustrated in FIG. 7 is the application of system 700 to various modes of transportation. For example, system 700 may be used in the control and/or entertainment systems of aircraft, trains, buses, cars for hire, private automobiles, waterborne vessels from private boats to cruise liners, scooters (for rent or owned), and so on. In various cases, system 700 may be used to provide automated guidance (e.g., self-driving vehicles), general systems control, and otherwise. These any many other embodiments are possible and are contemplated. It is noted that the devices and applications illustrated in FIG. 7 are illustrative only and are not intended to be limiting. Other devices are possible and are contemplated.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
an integrated circuit, the integrated circuit comprising multiple layers, the multiple layers comprising a first layer;
a sensing trace disposed on the first layer of the integrated circuit, the sensing trace comprising a first node coupled to a ground and a second node coupled to a current source;
a resistor circuit coupled to the sensing trace; and
a sensing circuit configured to detect damage to one or more layers of the multiple layers based on the sensing trace and the resistor circuit.

2. The apparatus of claim 1, wherein to detect damage to the one or more layers, the sensing circuit is configured to:
determine a resistance of the sensing trace when a current generated by the current source is provided to the sensing trace;
determine whether the resistance of the sensing trace is within a threshold of a target resistance; and
in response determining that the resistance of the sensing trace is not within the threshold the target resistance, determine that the integrated circuit may be damaged.

3. The apparatus of claim 2, wherein the sensing circuit is further configured to:
determine an extent of damage to the integrated circuit based on the resistance of the sensing trace.

4. The apparatus of claim 2, wherein the sensing circuit is further configured to:
determine the target resistance based on a temperature of the integrated circuit.

5. The apparatus of claim 1, further comprising:
one or more additional sensing traces disposed on the first layer of the integrated circuit; and
one or more additional resistor circuits coupled to the one or more additional sensing traces.

6. The apparatus of claim 5, wherein each of the sensing trace and the one or more additional sensing traces are disposed on different portions of the first layer of the integrated circuit.

7. The apparatus of claim 5, further comprising:
one or more additional sensing circuits, each of the one or more additional sensing circuits configured to detect damage to one or more layers of the multiple layers based on a respective sensing trace and a respective resistor circuit.

8. The apparatus of claim 5, wherein the sensing circuit is further configured to detect damage to one or more layers of the multiple layers based on the one or more additional sensing traces and the one or more additional resistor circuits.

9. The apparatus of claim 1, wherein the sensing trace is disposed around a perimeter of the integrated circuit.

10. The apparatus of claim 1, wherein the sensing trace is disposed above one or more active devices located in a layer below the first layer.

11. A method, comprising:
applying a current to a sensing trace disposed on a first layer of an integrated circuit, the sensing trace comprising a first node coupled to a ground and a second node coupled to a current source;
determining a resistance of the sensing trace; and
determining whether there may be damage to the integrated circuit based on the resistance of the sensing trace and a target resistance.

12. The method of claim 11, wherein determining whether there may be damage to the integrated circuit based on the resistance of the sensing trace and the target resistance comprises:
determining whether the resistance of the sensing trace is within a threshold of the target resistance.

13. The method of claim 12, further comprising:
determining that there may be damage to the integrated circuit when the resistance of the sensing trace is not within the threshold of the target resistance.

14. The method of claim 13, further comprising:
determining an extent of damage to the integrated circuit based on the resistance of the sensing trace.

15. A circuit, comprising:
a first layer comprising one or more active devices; and
a second layer disposed above the first layer, the second layer comprising:
a sensing trace comprising a first node coupled to a ground and a second node coupled to a current source; and
a resistor circuit coupled to the sensing trace, wherein the sensing trace is coupled to a sensing circuit configured to detect damage to the one or more active devices based on the sensing trace and the resistor circuit.

16. The circuit of claim 15, wherein to detect damage to the one or more active devices, the sensing circuit is configured to:
determine a resistance of the sensing trace when a current generated by the current source is provided to the sensing trace;
determine whether the resistance of the sensing trace is within a threshold of a target resistance; and
in response determining that the resistance of the sensing trace is not within the threshold the target resistance, determine that the one or more active devices may be damaged.

17. The circuit of claim 15, wherein the second layer further comprises:
one or more additional sensing traces; and
one or more additional resistor circuits coupled to the one or more additional sensing traces.

18. The circuit of claim 17, wherein the one or more additional sensing traces are coupled to one or more additional sensing circuits, and each of the one or more additional sensing circuits configured to detect damage to the one or more active devices based on a respective sensing trace and a respective resistor circuit.

19. The circuit of claim 17, wherein the sensing circuit is further configured to detect damage to the one or more active devices based on the one or more additional sensing traces and the one or more additional resistor circuits.

20. The circuit of claim 15, wherein the sensing trace is disposed around a perimeter of the circuit.
